(19) United States
(12) Patent Application Publication
(10) Pub. No.: US 2025/0370511 A1
(43) Pub. Date: Dec. 4, 2025

(54) ELECTRONIC APPARATUS

(71) Applicant: LENOVO (SINGAPORE) PTE. LTD., SINGAPORE (SG)

(72) Inventors: Yoshihito Nakagaki, YOKOHAMA (JP); Nancy Malik, YOKOHAMA (JP); Makoto Hashikura, YOKOHAMA (JP)

(73) Assignee: LENOVO (SINGAPORE) PTE. LTD., SINGAPORE (SG)

(21) Appl. No.: 19/169,545

(22) Filed: Apr. 3, 2025

(30) Foreign Application Priority Data
May 30, 2024 (JP) 2024087847

(51) Int. Cl. G06F 1/16; F21V 8/00; G06F 1/18

(52) U.S. Cl. CPC G06F 1/1658; G02B 6/009; G06F 1/188

(57) ABSTRACT

An electronic apparatus includes a chassis having a cover plate and side plates, a light emitting portion provided inside the chassis, a light guide body having a tip protruding portion, and a biasing structure which biases the light guide body. The side plate is formed with an insertion portion which penetrates from an inner surface of the side plate to an outer surface thereof. The light guide body is movable in a direction of approaching and moving away from the side plate. The tip protruding portion protrudes from the outer surface of the side plate so as to be able to protrude from and retract into the insertion portion. The biasing structure biases the light guide body in a protruding direction of the tip protruding portion by an elastic repulsive force.

### BACKGROUND OF THE INVENTION

### Field of the Invention

The present invention relates to an electronic apparatus.

### Description of the Related Art

An electronic apparatus is provided with a display unit on a side surface of a chassis, for example, which emits light using an LED or the like. The display unit indicates that a battery is charging, for example (refer to, for example, Japanese Unexamined Patent Application Publication No. 2019-120979).

### SUMMARY OF THE INVENTION

In the electronic apparatus, a light guide body constituting the display unit may be formed protruding from the side surface of the chassis. In an electronic apparatus having such a configuration, a protruding portion may come into contact with other objects. In order to avoid damage, there has been a demand for the prevention of an excessive external force from being applied to the protruding portion.

One aspect of the present invention aims to provide an electronic apparatus capable of suppressing an external force applied to a light guide body protruded from a chassis.

An electronic apparatus according to one aspect of the present invention includes a chassis having a cover plate and side plates each formed at a side edge of the cover plate, a light emitting portion provided inside the chassis, a light guide body which has a tip protruding portion and guides light from the light emitting portion, and a biasing structure which biases the light guide body. The side plate is formed with an insertion portion which penetrates from an inner surface of the side plate to an outer surface thereof. The light guide body is movable in a direction of approaching and moving away from the side plate. The tip protruding portion protrudes from the outer surface of the side plate so as to be able to protrude from and retract into the insertion portion. The biasing structure biases the light guide body in a protruding direction of the tip protruding portion by an elastic repulsive force.

It is preferable that the biasing structure is an elastic piece connected to the light guide body and obtains the repulsive force by elastic bending deformation.

It is preferable that the electronic apparatus further includes a holding member which holds the light guide body and that the holding member includes two side walls and a pressure receiving wall which connects the side walls together, and the biasing structure takes a reaction force against the pressure receiving wall to obtain the repulsive force.

It is preferable that the electronic apparatus further includes a holding member which has two side walls and holds the light guide body between the two side walls and that the biasing structure connects the side walls together and the biasing structure is formed with a biasing portion which obtains the repulsive force by elastic bending deformation.

It is preferable that the biasing portion has a shape curved to be convex in the protruding direction.

It is preferable that the light guide body is formed with a receiving recessed portion which accommodates at least a part of the light emitting portion.

The biasing structure may be configured to obtain the repulsive force by elastic compressive deformation.

The cover plate may be formed with a guide portion which guides the light guide body in a direction in which the light guide body approaches and moves away from the side plate.

According to one aspect of the present invention, it is possible to provide an electronic apparatus capable of suppressing an external force applied to a light guide body protruded from a chassis.

### BRIEF DESCRIPTION OF THE DRAWINGS

FIG. 1 is a perspective view of an electronic apparatus according to a first embodiment;

FIG. 2 is a perspective view of a part of the electronic apparatus according to the first embodiment;

FIG. 3 is a perspective view of the part of the electronic apparatus according to the first embodiment;

FIG. 4 is a perspective view of a part of the electronic apparatus according to the first embodiment;

FIG. 5 is a configuration view of a part of the electronic apparatus according to the first embodiment;

FIG. 6 is a perspective view of a part of the electronic apparatus according to the first embodiment;

FIG. 7 is a perspective view of the part of the electronic apparatus according to the first embodiment;

FIG. 8 is a perspective view illustrating the structure of the electronic apparatus according to the first embodiment;

FIG. 9 is a perspective view illustrating the structure of the electronic apparatus according to the first embodiment;

FIG. 10 is a cross-sectional view of a part of the electronic apparatus according to the first embodiment;

FIG. 11 is a cross-sectional view of the part of electronic apparatus according to the first embodiment;

FIG. 12 is a perspective view of a part of an electronic apparatus according to a second embodiment;

FIG. 13 is a perspective view illustrating the structure of the electronic apparatus according to the second embodiment;

FIG. 14 is a perspective view illustrating the structure of the electronic apparatus according to the second embodiment;

FIG. 15 is a plan view of a part of the electronic apparatus according to the second embodiment;

FIG. 16 is a plan view of the part of the electronic apparatus according to the second embodiment;

FIG. 17 is a cross-sectional view of the part of the electronic apparatus according to the second embodiment;

FIG. 18 is a cross-sectional view of the part of the electronic apparatus according to the second embodiment;

FIG. 19 is a cross-sectional view of a part of an electronic apparatus according to a third embodiment;

FIG. 20 is a perspective view of the part of the electronic apparatus according to the third embodiment; and

FIG. 21 is an exploded perspective view of the part of the electronic apparatus according to the third embodiment.

### DETAILED DESCRIPTION OF THE INVENTION

Electronic apparatuses according to embodiments will be described.

### [Electronic Apparatus] (First Embodiment)

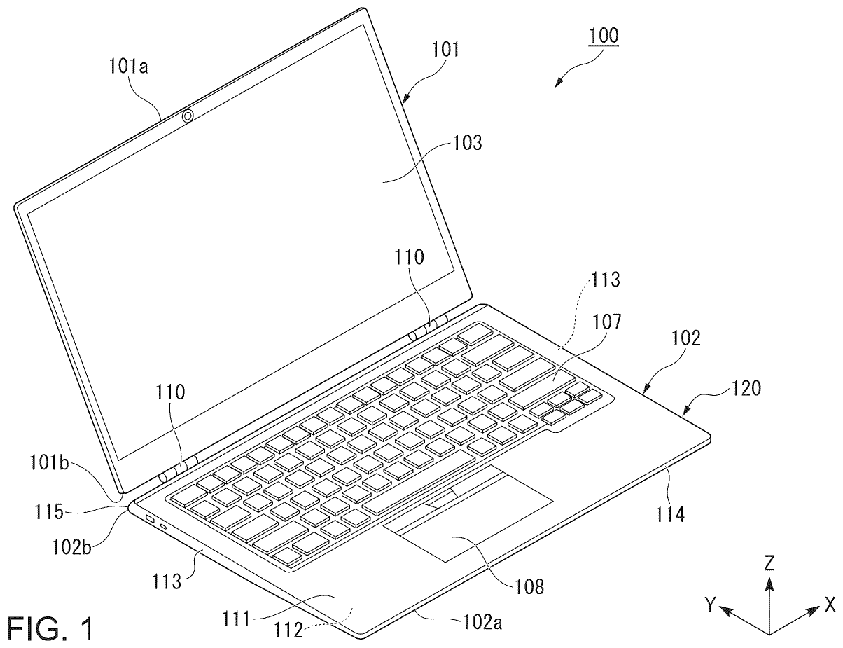

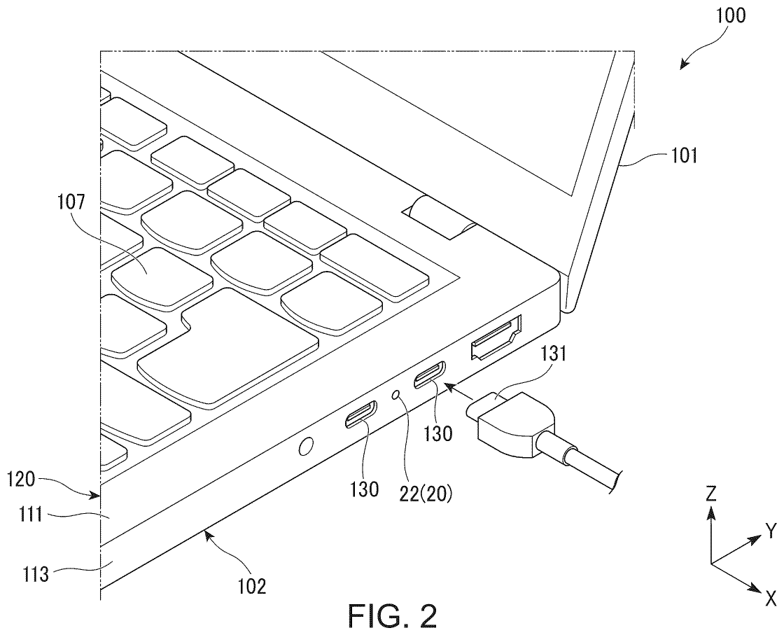

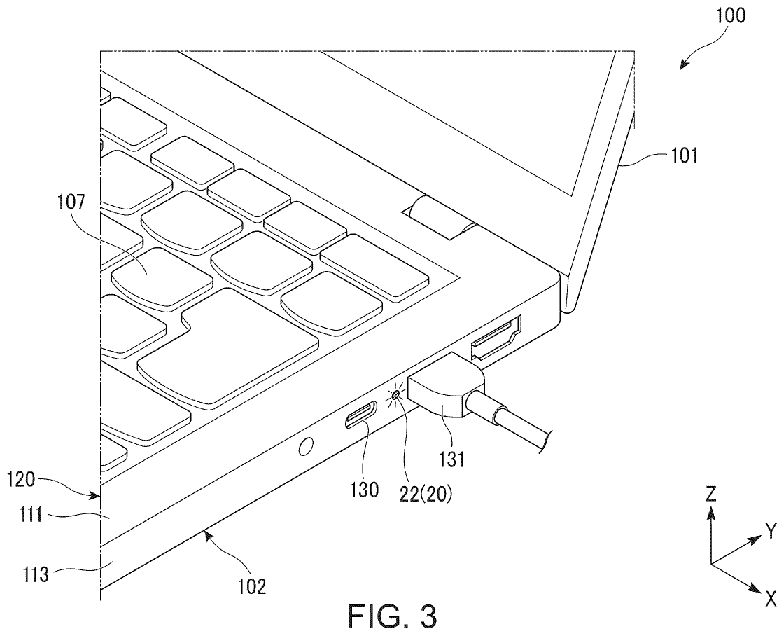

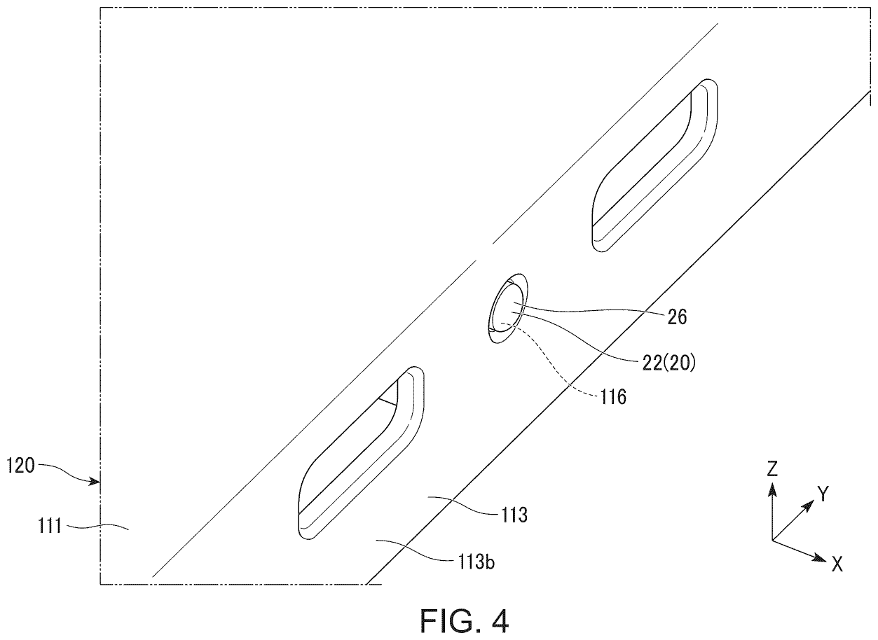

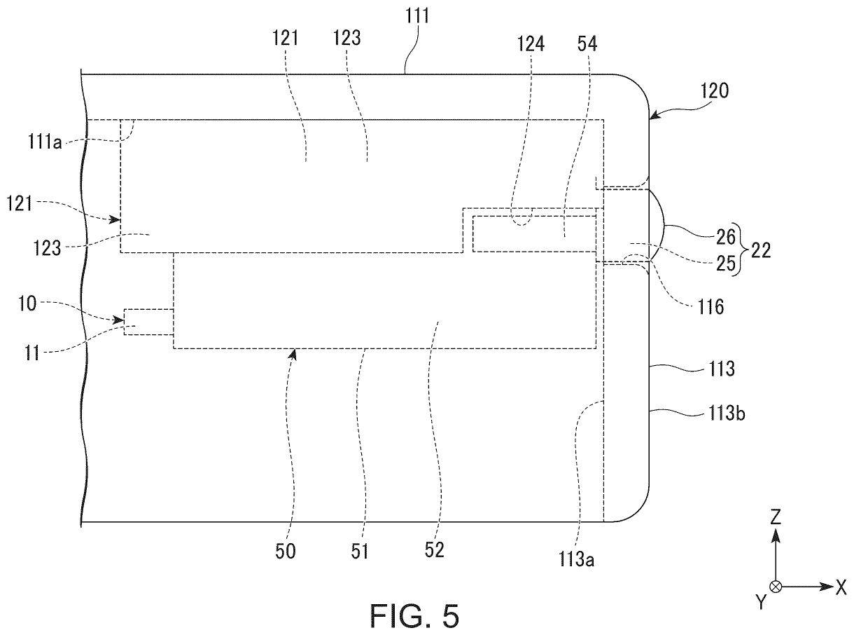

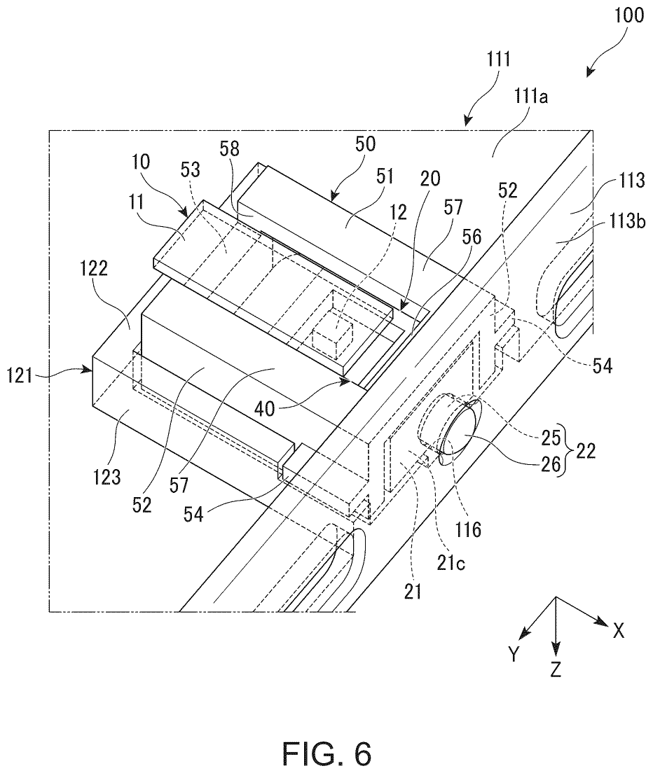

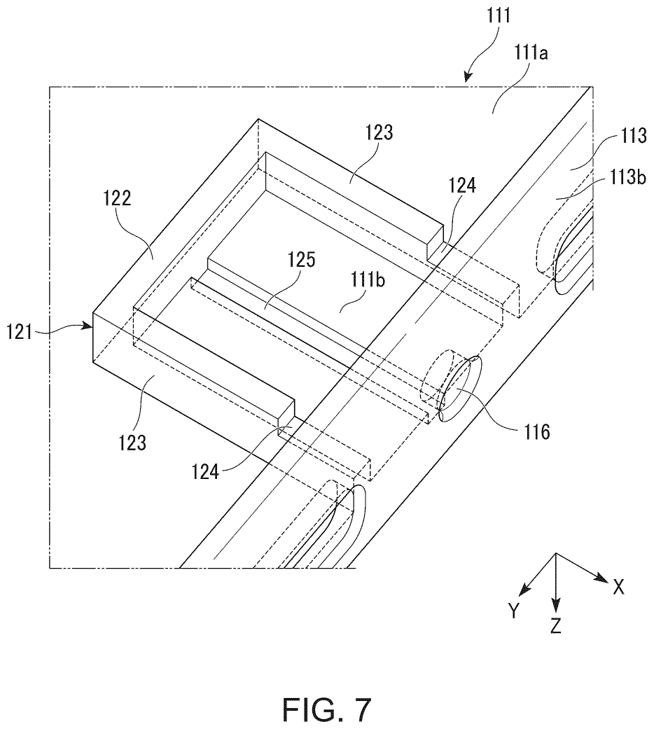

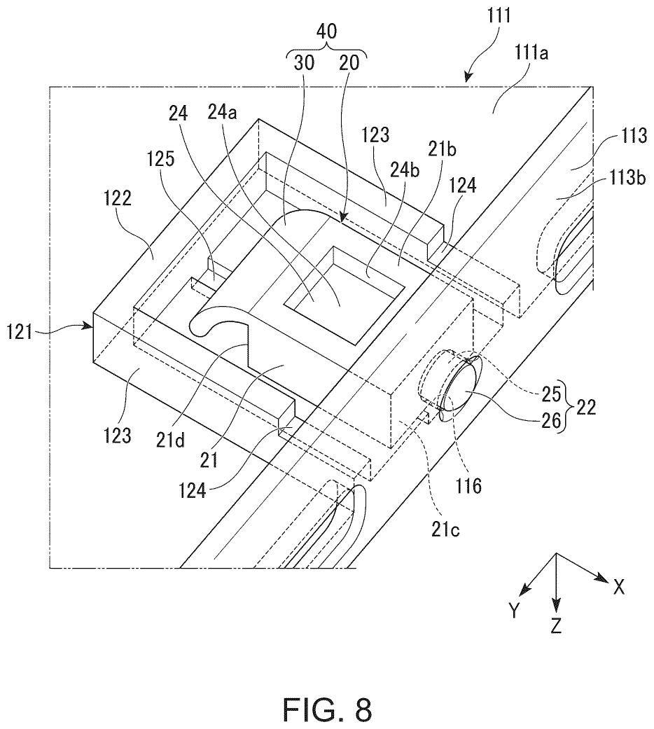

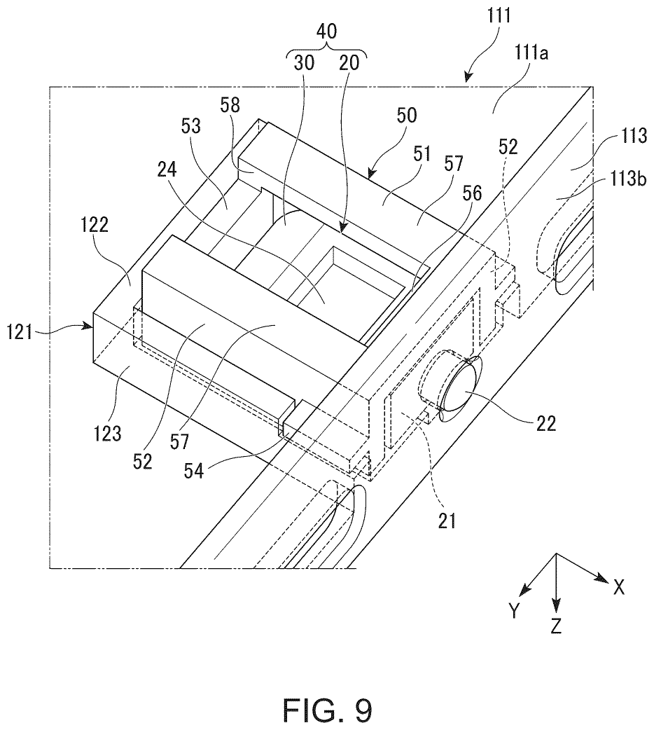

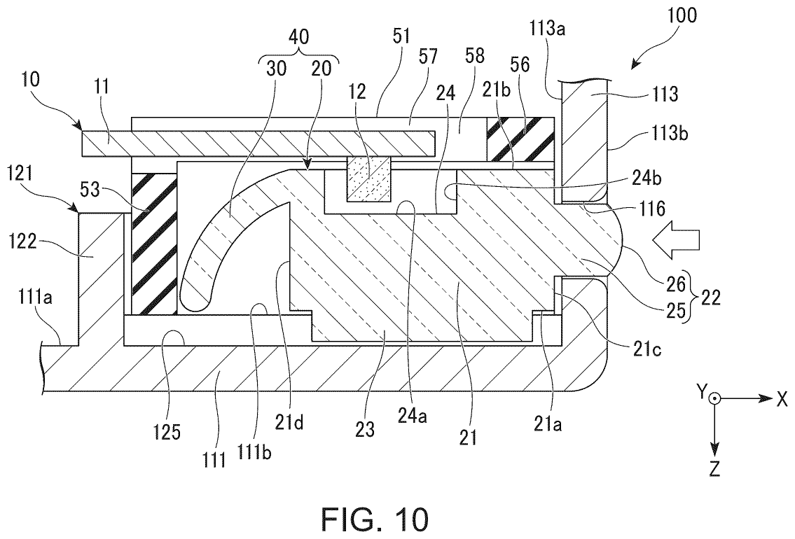

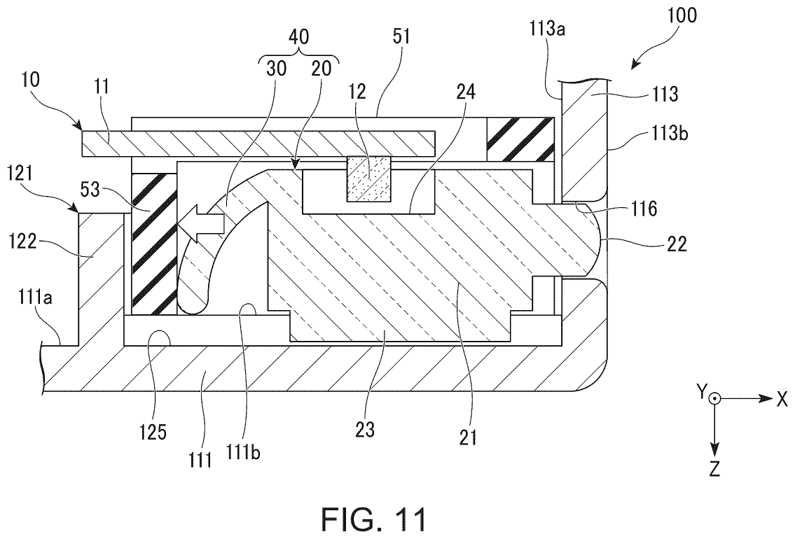

FIG. 1 is a perspective view of an electronic apparatus 100 according to a first embodiment. FIGS. 2 and 3 are perspective views of a part of the electronic apparatus 100. FIG. 4 is a perspective view of a part of the electronic apparatus 100. FIG. 5 is a configuration view of a part of the electronic apparatus 100. FIGS. 6 and 7 are perspective views of a part of the electronic apparatus 100. FIGS. 8 and 9 are perspective views illustrating the structure of the electronic apparatus 100. FIGS. 10 and 11 are cross-sectional views of a part of the electronic apparatus 100. FIGS. 10 and 11 each illustrate a cross section taken along an XZ plane.

As illustrated in FIG. 1, the electronic apparatus 100 includes a first chassis 101, a second chassis 102 (chassis), a light emitting unit 10 (refer to FIG. 6), a light guide body unit 40 (refer to FIG. 8), and a holding member 50 (refer to FIG. 6).

The electronic apparatus 100 is, for example, a laptop PC (PC: personal computer). The first chassis 101 and the second chassis 102 have ends connected to each other via hinge mechanisms 110. The first chassis 101 is capable of rotating relatively to the second chassis 102 around a rotational axis defined by each of the hinge mechanisms 110.

The first chassis 101 is also called a display chassis. The first chassis 101 is formed in a rectangular plate shape. Of the ends of the first chassis 101, the end where the hinge mechanism 110 is provided is a first base end 101b. The end opposite to the first base end 101b is a first open end 101a. The first chassis 101 is mounted with a display 103. The display 103 is, for example, a liquid crystal display, an organic EL (Electro-Luminescence) display, or the like.

The second chassis 102 is also called a system chassis. The second chassis 102 is formed in a rectangular plate shape. Of the ends of the second chassis 102, the end where the hinge mechanism 110 is provided is a second base end 102b. The end opposite to the second base end 102b is a second open end 102a.

The second chassis 102 is mounted with a keyboard 107 and a touch pad 108. The second chassis 102 accommodates electronic components such as a CPU, a memory, a motherboard, a battery, and a storage device.

Regarding the second chassis 102, the positional relationship of each configuration may be described using an XYZ orthogonal coordinate system. An X direction is a longitudinal direction of a first cover plate 111. A Y direction is a lateral direction of the first cover plate 111. The Y direction is orthogonal to the X direction. A Z direction is orthogonal to the X direction and the Y direction. The Z direction is a thickness direction of the first cover plate 111. Viewing from the Z direction is called a plan view. +Z is the direction from a second cover plate 112 toward the first cover plate 111. −Z is the direction opposite to +Z. A plane including the X direction and the Y direction is an XY plane. A plane including the X direction and the Z direction is an XZ plane. A plane including the Y direction and the Z direction is a YZ plane.

The second chassis 102 includes a chassis main part 120 and the second cover plate 112. The second chassis 102 is a flat plate-shaped case. The second chassis 102 is constituted of, for example, plastic, a metal, or the like.

The chassis main part 120 includes the first cover plate 111, a pair of side plates 113, a front plate 114, and a rear plate 115.

The first cover plate 111 has a rectangular shape in a plan view. The pair of side plates 113 are formed at one and the other side edge of the first cover plate 111, respectively. The side plate 113 is formed perpendicular to the first cover plate 111. The side plate 113 is, for example, parallel to the YZ plane. The first cover plate 111 is an example of a “cover plate”.

The front plate 114 is formed at the front edge (second open end 102a) of the first cover plate 111. The rear plate 115 is formed at the rear edge (second base end 102b) of the first cover plate 111.

The second cover plate 112 has a rectangular shape in a plan view. The second cover plate 112 faces the first cover plate 111 in spaced relation to the first cover plate 111. When the second chassis 102 is placed on a placement surface (such as the top surface of a desk), the second cover plate 112 faces the placement surface. The second cover plate 112 is an example of a “cover plate”.

As illustrated in FIGS. 2 and 3, the side plate 113 is provided with one or more apparatus-side connectors 130. A connection-side connector 131 can be connected to the apparatus-side connector 130. The apparatus-side connector 130 and the connection-side connector 131 are, for example connectors which comply with USB (Universal Serial Bus) Type-C. The electronic apparatus 100 can charge the battery by, for example, connecting the connection-side connector 131 connected to a power supply device to the apparatus-side connector 130.

As illustrated in FIGS. 4 and 7, the side plate 113 is formed with an insertion portion 116. The insertion portion 116 is a through hole formed from an inner surface 113a (refer to FIG. 5) of the side plate 113 to an outer surface 113b thereof. The insertion portion 116 passes through the side plate 113 in its thickness direction. The insertion portion 116 has, for example, a circular shape when viewed from the X direction. The inner surface 113a is one surface of the side plate 113. The inner surfaces 113a of the two side plates 113 face each other. The outer surface 113b is the other surface of the side plate 113.

As illustrated in FIGS. 5 and 7, a holding protruding portion 121 is formed on a surface 111a on the −Z side of the first cover plate 111. The holding protruding portion 121 protrudes from the surface 111a to the −Z side. The holding protruding portion 121 is formed in a rectangular frame shape. The holding protruding portion 121 is formed integrally with the first cover plate 111, for example.

As illustrated in FIG. 7, the holding protruding portion 121 includes a base 122 and two side portions 123. The base 122 is formed in a position spaced apart from the side plate 113 in the X direction so as to be parallel to the Y direction. The two side portions 123 each extend parallel to the X direction from one and the other ends of the base 122 toward the side plate 113. The tip of the side portion 123 reaches the inner surface 113a of the side plate 113 (refer to FIG. 5).

A locking recessed portion 124 is formed in a location including the tip of the side portion 123. The locking recessed portion 124 is formed lower than the other portion of the side portion 123 so as to be made in a recessed shape. The locking recessed portion 124 has a rectangular shape when viewed from the Y direction.

As illustrated in FIG. 6, a part of the light guide body unit 40 (refer to FIG. 8) and a part of the holding member 50 are accommodated in a space inside the holding protruding portion 121. The base 122 restricts the light guide body unit 40 and the holding member 50 from moving backward. The side portion 123 restricts the light guide body unit 40 and the holding member 50 from moving in the Y direction.

As illustrated in FIG. 7, a guide groove 125 (guide portion) is formed in a surface 111b (a surface on the −Z side of the first cover plate 111) of a portion surrounded by the holding protruding portion 121. The guide groove 125 is formed parallel to the X direction. The guide groove 125 is formed from the base 122 to the side plate 113. A cross section of the guide groove 125 perpendicular to the longitudinal direction thereof is, for example, rectangular. The guide groove 125 guides a light guide body 20 in the X direction (front-rear direction). The guide groove 125 guides the light guide body 20 in the direction of approaching and moving away from the side plate 113.

As illustrated in FIGS. 6 and 10, the light emitting unit 10 includes a substrate 11 and a light emitting portion 12. The light emitting unit 10 is provided inside the second chassis 102.

The substrate 11 is formed in a rectangular plate shape parallel to the XY plane. The substrate 11 has a rectangular shape with its long sides extending along the X direction in a plan view. The substrate 11 may be a flexible printed circuit board (FPC) or a rigid substrate. A portion including the front end of the substrate 11 is disposed in an opening portion 58 of the holding member 50 in a plan view.

The light emitting portion 12 is, for example, a light emitting diode (LED). The light emitting portion 12 emits visible light (for example, wavelengths of 380 nm to 770 nm). The light emitting portion 12 is formed on the +Z side surface of the substrate 11. The light emitting portion 12 protrudes from the +Z side surface of the substrate 11.

As illustrated in FIGS. 2 and 3, for example, when the connection-side connector 131 connected to the power supply device is connected to the apparatus-side connector 130, the electronic apparatus 100 can charge the battery. The electronic apparatus 100 has a control unit (not illustrated) which controls the light emitting unit 10.

For example, when the connection-side connector 131 is not connected to the apparatus-side connector 130, the control unit does not cause the light emitting portion 12 to emit light. Therefore, a tip protruding portion 22 does not light up (refer to FIG. 2). The control unit causes the light emitting portion 12 to emit light, for example, when the connection-side connector 131 is connected to the apparatus-side connector 130 to charge the battery. Consequently, the tip protruding portion 22 lights up (refer to FIG. 3).

A user can recognize that the battery is being charged by lighting of the tip protruding portion 22. The control unit may change the color of the light emitted by the light emitting portion 12 when the charging rate of the battery reaches 100%. For example, the control unit can perform such control that, for example, the tip protruding portion 22 lights up with light of a first color during charging, and the light of the tip protruding portion 22 changes to another color when charging is completed.

As illustrated in FIGS. 8 and 10, the light guide body unit 40 includes a light guide body 20 and a biasing structure 30. The light guide body unit 40 is provided inside the second chassis 102.

The light guide body 20 is made transparent. The light guide body 20 is capable of transmitting visible light. The light guide body 20 is formed of a resin such as polyethylene terephthalate (PET), polycarbonate, or an acrylic resin. The light guide body 20 guides the light from the light emitting portion 12.

The light guide body 20 includes a main body 21, a tip protruding portion 22, and a guide protruding portion 23. The main body 21 is formed in a rectangular parallelepiped shape. A surface (first main surface 21a) on the +Z side of the main body 21 (refer to FIG. 10) faces the surface 111b surrounded by the holding protruding portion 121. A surface (second main surface 21b) on the −Z side of the main body 21 is parallel to the first main surface 21a. The first main surface 21a and the second main surface 21b are, for example, parallel to the XY plane.

A tip surface 21c of the main body 21 faces the inner surface 113a of the side plate 113 (refer to FIG. 10). A rear end surface 21d is a surface opposite to the tip surface 21c. The tip surface 21c and the rear end surface 21d are perpendicular to the first main surface 21a. The tip surface 21c and the rear end surface 21d are parallel to, for example, the YZ plane.

The guide protruding portion 23 protrudes from the first main surface 21a of the main body 21 to the +Z side. The guide protruding portion 23 extends in the X direction. A cross section of the guide protruding portion 23 perpendicular to its longitudinal direction is, for example, rectangular. The guide protruding portion 23 is inserted into the guide groove 125.

The second main surface 21b (outer surface) of the main body 21 is formed with a receiving recessed portion 24. The receiving recessed portion 24 is capable of accommodating at least a part of the light emitting portion 12. The receiving recessed portion 24 has a rectangular shape in a plan view. The receiving recessed portion 24 has a size to encompass the light emitting portion 12 in a plan view. The receiving recessed portion 24 includes a rectangular bottom surface 24a and four side surfaces 24b. The bottom surface 24a is parallel to the second main surface 21b. The side surface 24b is perpendicular to the bottom surface 24a. It is desirable that the inner surface of the receiving recessed portion 24 does not come into contact with the light emitting portion 12.

The tip protruding portion 22 protrudes forward (rightwards in FIG. 10) from the tip surface 21c of the main body 21 toward the insertion portion 116. The tip protruding portion 22 is formed in the center of the tip surface 21c. The tip protruding portion 22 protrudes perpendicularly to the tip surface 21c.

The tip protruding portion 22 has a main portion 25 and a tip convex 26. The main portion 25 is formed in a cylindrical shape having a central axis parallel to the X direction. The tip convex 26 is formed at the tip of the main portion 25. An outer surface of the tip convex 26 serves as a curved convex surface (e.g., a spherical surface) which is convexed forward. The tip convex 26 is formed integrally with the main portion 25.

The main body 21 receives the light emitted by the light emitting portion 12 in the receiving recessed portion 24. The tip protruding portion 22 guides light from the main body 21 and emits it from the tip convex 26.

The light guide body 20 is movable along the guide groove 125 in a state in which the guide protruding portion 23 is inserted into the guide groove 125 (refer to FIG. 11). The direction in which the light guide body 20 approaches the side plate 113 (the right in FIG. 10) is the “front”. The direction in which the light guide body 20 moves away from the side plate 113 (the left in FIG. 10) is the “rear”.

The biasing structure 30 is an elastic piece connected to the main body 21. The biasing structure 30 is formed in a plate shape which can be elastically bent and deformed. The biasing structure 30 biases the light guide body 20 forward by an elastic repulsive force.

The biasing structure 30 extends with the end on the −Z side of the rear end surface 21d as a base end. The biasing structure 30 may be in the form of a plate curved in its thickness direction. The biasing structure 30 extends rearward from the base end while inclining toward the +Z side. The angle of inclination of the biasing structure 30 relative to the X direction increases as it approaches its tip. The biasing structure 30 is curved into, for example, an arc shape when viewed from the Y direction. The width (dimension in the Y direction) of the biasing structure 30 may be the same as the width of the main body 21. The biasing structure 30 is formed integrally with the main body 21, for example. The biasing structure 30 is constituted of, for example, the same material as the light guide body 20.

As illustrated in FIG. 9, the holding member 50 includes a main wall 51, two side walls 52, a rear wall 53 (pressure receiving wall), and two locking protruding portions 54. The holding member 50 holds the light guide body unit 40 between the two side walls 52.

The main wall 51 is formed in a rectangular shape as a whole. The main wall 51 is located on the −Z side with respect to the light guide body unit 40 and can restrict the light guide body unit 40 from moving to the −Z side. The main wall 51 is, for example, in the form of a plate parallel to the XY plane. The main wall 51 includes a front portion 56 and two side portions 57. The front portion 56 has a long plate shape extending along the Y direction. The two side portions 57 extend rearward from one and the other ends of the front portion 56, respectively. The two side portions 57 are spaced apart in the Y direction. An opening portion 58 formed between the two side portions 57 exposes the receiving recessed portion 24.

The two side walls 52 protrude from one and the other side edges of the main wall 51 toward the +Z side, respectively. The side wall 52 has, for example, a rectangular plate shape parallel to the XZ plane. The side wall 52 extends in the X direction. The sided wall 52 can restrict the movement of the light guide body unit 40 in the Y direction. The two side walls 52 may have a function of guiding the movement of the light guide body 20 in the front-rear direction.

The rear wall 53 connects rear ends of the two side walls 52 together. The rear wall 53 has a rectangular plate shape parallel to the YZ plane. The rear wall 53 is located on the rear side with respect to the light guide body unit 40. A space surrounded by the main wall 51, the two side walls 52, and the rear wall 53 is an accommodation space which accommodates the light guide body unit 40 therein.

A part (portion on the +Z side) of the side wall 52 and a part (portion on the +Z side) of the rear wall 53 are disposed inside the holding protruding portion 121.

The two locking protruding portions 54 are formed at the front portions of the two side walls 52, respectively. They protrude outward from the outer surfaces of the side walls 52 respectively. The “outward” refers to the direction in which the two side walls 52 move away from each other. The locking protruding portion 54 is, for example, in the form of a rectangular plate parallel to the XY plane. The locking protruding portion 54 engages with the locking recessed portion 124 (refer to FIG. 7) of the holding protruding portion 121.

The holding member 50 can be formed of rubber, a resin, or the like.

As illustrated in FIG. 10, when the light emitting portion 12 emits light, the light enters the main body 21 from the bottom surface 24a and the side surface 24b of the receiving recessed portion 24. A part of the light enters the tip protruding portion 22 and exits from the tip convex 26. Consequently, the tip protruding portion 22 lights up.

The operation of the light guide body 20 and the biasing structure 30 will be described.

As illustrated in FIGS. 10 and 11, the light guide body 20 is switchable between a forward position (refer to FIG. 10) and a rearward position (refer to FIG. 11) by movement in the forward and backward directions. At the forward position (refer to FIG. 10), the tip of the tip protruding portion 22 (the portion including the tip convex 26) protrudes from the outer surface 113b of the side plate 113. At the rearward position (refer to FIG. 11), the tip protruding portion 22 assumes a state of not protruding from the outer surface 113b (i.e., a non-protruding state). Therefore, the tip protruding portion 22 can protrude from and retract into the outer surface 113b of the side plate 113.

As illustrated in FIG. 10, at the forward position, for example, the rear wall 53 of the holding member 50 restricts the light guide body unit 40 from moving backward. Therefore, the state in which the part of the tip protruding portion 22 protrudes from the outer surface 113b is maintained. Since the tip protruding portion 22 in this state protrudes from the outer surface 113b, the position can be confirmed by touching it with a finger.

As illustrated by an arrow in FIG. 10, there is a possibility that an external force may be applied to the tip protruding portion 22 serving as the portion protruded from the side plate 113 by coming into contact with an external object, etc. In the example illustrated in FIG. 11, the application of the external force to the tip protruding portion 22 causes the light guide body 20 to retract, and the tip protruding portion 22 to enter a non-protruding state. As the light guide body 20 retracts, the biasing structure 30 is pressed against the rear wall 53, and then bent and deformed. The biasing structure 30 exerts a reaction force on the rear wall 53 and presses the light guide body 20 forward by an elastic repulsive force. Therefore, when the external force weakens, the light guide body 20 returns to the forward position (refer to FIG. 10).

[Effects Brought about by Electronic Apparatus According to Embodiment]

According to the electronic apparatus 100, the light guide body 20 allows the tip protruding portion 22 to be protruded and retracted from the side plate 113. Therefore, when the external force is applied to the tip protruding portion 22, the light guide body 20 retracts and the tip protruding portion 22 is brought into a non-protruding state. This can reduce the impact applied to the tip protruding portion 22, thereby making the tip protruding portion 22 less likely to be damaged. Since the tip protruding portion 22 can be protruded and retracted, it is also possible to make an external object less likely to be damaged when the external object comes into contact with the tip protruding portion 22.

Since the biasing structure 30 is the elastic piece which obtains the repulsive force by bending deformation, it is possible to simplify the structure for biasing the light guide body 20.

Since the elastic repulsive force is obtained by applying the reaction force to the rear wall 53 of the holding member 50, the biasing structure 30 can obtain a sufficient biasing force against the light guide body 20.

Since the electronic apparatus 100 has the holding member 50, it can suppress leakage of light from the light emitting portion 12.

The main body 21 has the receiving recessed portion 24 which accommodates at least a part of the light emitting portion 12. This structure allows the overall height dimension (dimension in the Z direction) of the light guide body 20 and the light emitting unit 10 to be reduced. Therefore, it is possible to save space.

Since the first cover plate 111 is formed with the guide groove 125 which guides the light guide body 20 in the front-rear direction, the light guide body 20 can be operated stably.

### [Electronic Apparatus] (Second Embodiment)

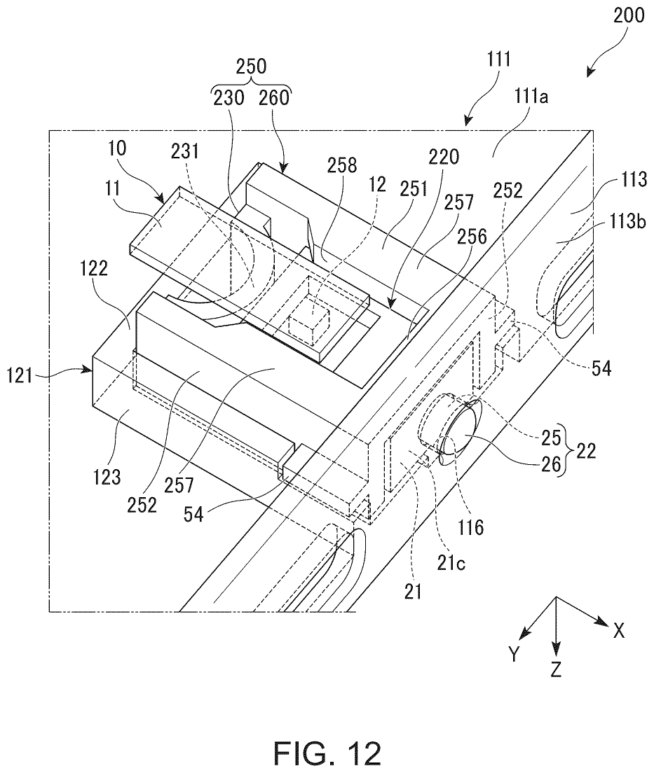

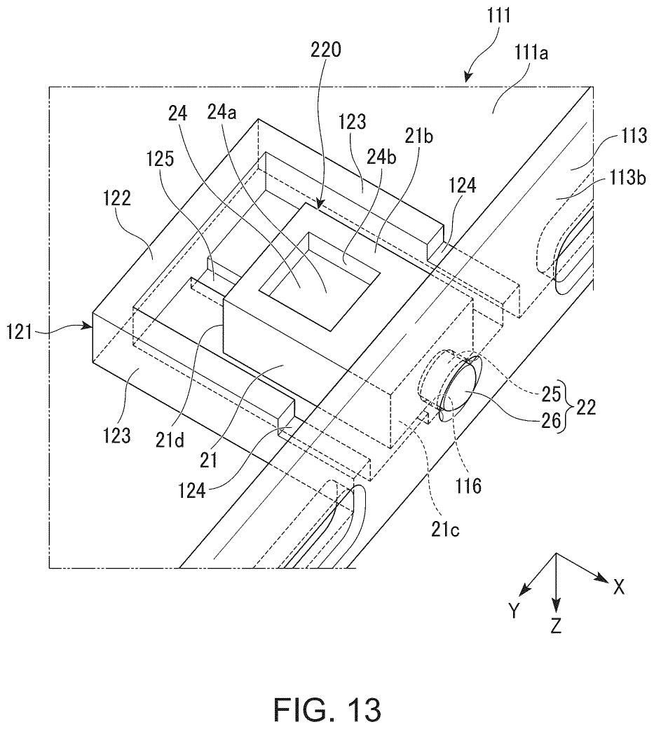

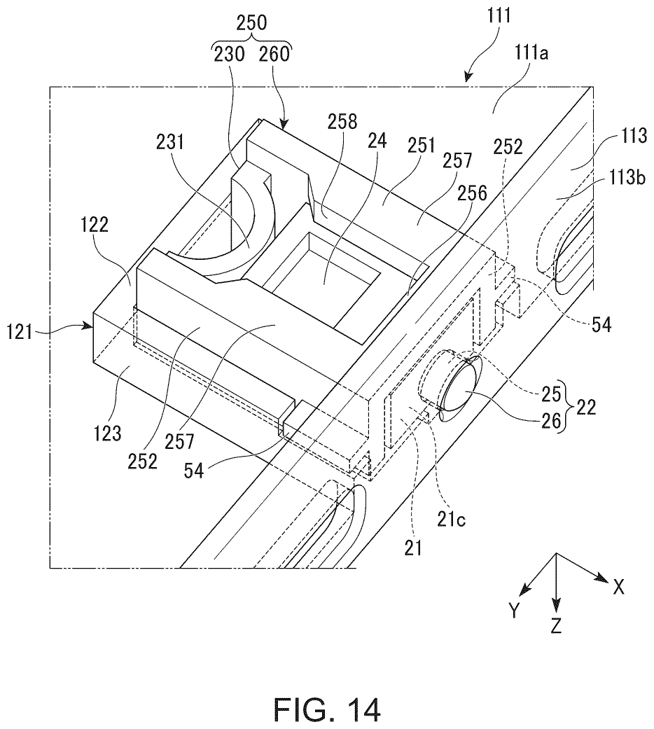

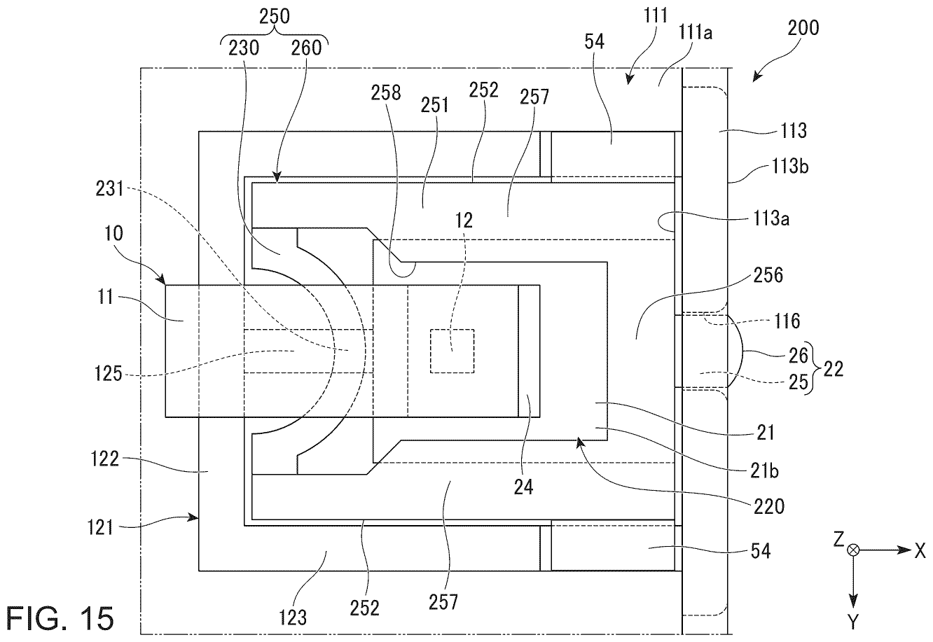

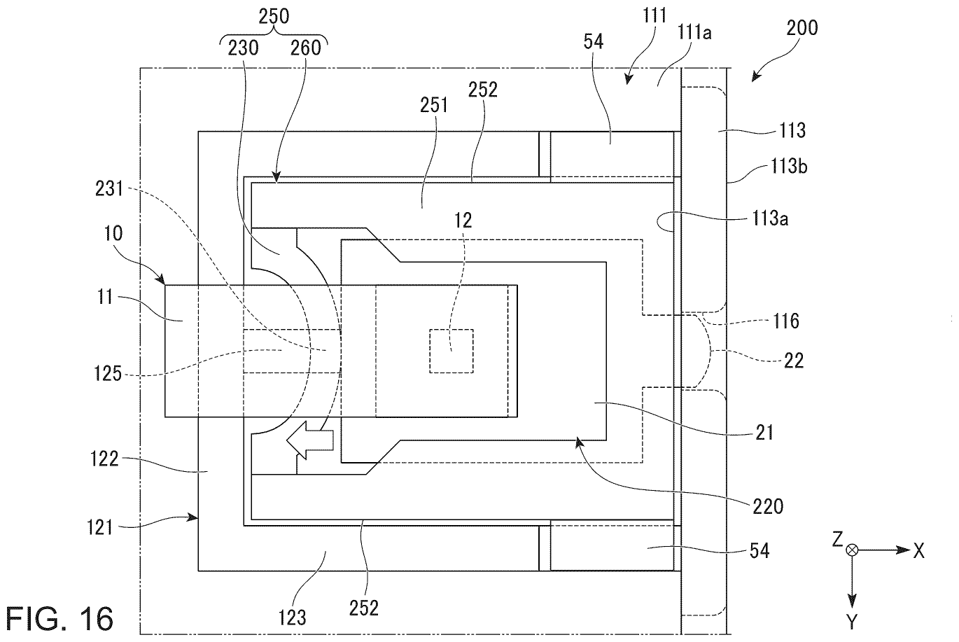

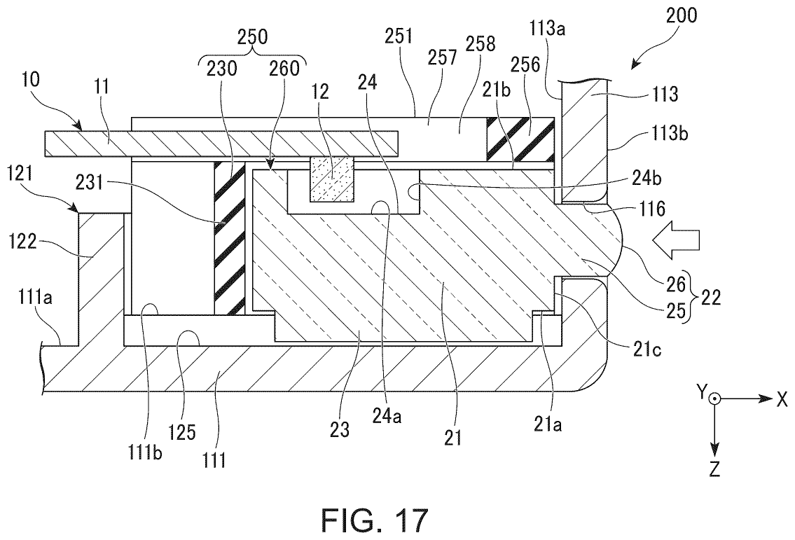

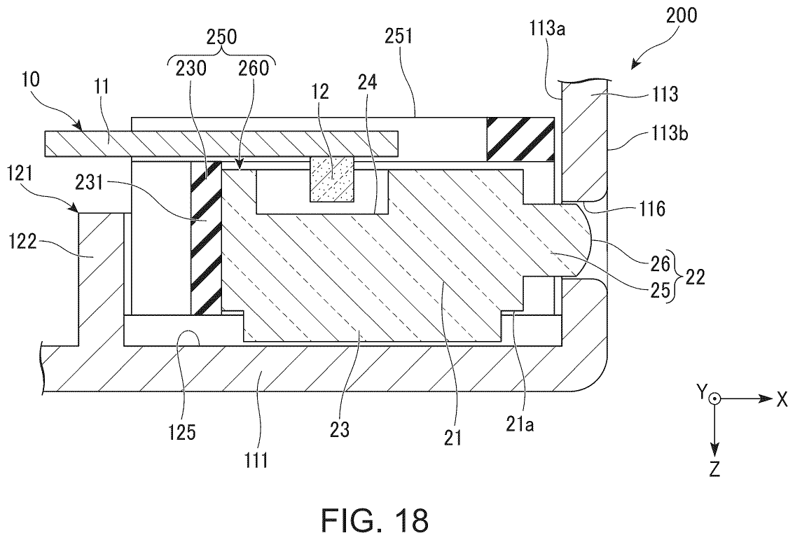

FIG. 12 is a perspective view of a part of an electronic apparatus 200 according to a second embodiment. FIGS. 13 and 14 are perspective views illustrating a structure of the electronic apparatus 200. FIGS. 15 and 16 are plan views of the part of the electronic apparatus 200. FIGS. 17 and 18 are cross-sectional views of the part of the electronic apparatus 200. FIGS. 17 and 18 illustrate cross sections taken along an XZ plane. Components common to the electronic apparatus 100 (refer to FIGS. 1 to 11) according to the first embodiment are designated by the same reference numerals, and their description will be omitted.

As illustrated in FIG. 12, the electronic apparatus 200 includes a first chassis 101 (refer to FIG. 1), a second chassis 102 (refer to FIG. 1), a light emitting unit 10, a light guide body 220, and a holding unit 250. The electronic apparatus 200 is different from the electronic apparatus 100 (refer to FIG. 6) in that the light guide body 220 is used instead of the light guide body unit 40 (refer to FIG. 8) and the holding unit 250 is used instead of the holding member 50.

As illustrated in FIGS. 12 and 15, the light emitting unit 10 includes a substrate 11 and a light emitting portion 12. A portion including a front end of the substrate 11 is arranged in an opening portion 258 of the holding unit 250.

As illustrated in FIG. 13, the light guide body 220 is of similar configuration to the light guide body 20 (refer to FIG. 8). As illustrated in FIGS. 17 and 18, the light guide body 220 is movable along a guide groove 125 in a state in which a guide protruding portion 23 is inserted into the guide groove 125.

As illustrated in FIGS. 14 and 15, the holding unit 250 includes a holding member 260 and a biasing structure 230.

The holding member 260 includes a main wall 251, two side walls 252, and two locking protruding portions 54. The holding member 260 holds the light guide body 220 between the two side walls 252.

The main wall 251 is located on the −Z side with respect to the light guide body 220 and can restrict the light guide body 220 from moving to the −Z side. The main wall 251 is, for example, in the form of a plate parallel to an XY plane. The main wall 251 includes a front portion 256 and two side portions 257. The front portion 256 has a long plate shape extending along a Y direction. The two side portions 257 extends rearward from one and the other ends of the front portion 256, respectively. The two side portions 257 are spaced apart in the Y direction. The opening portion 258 formed between the two side portions 257 exposes a receiving recessed portion 24.

The two side walls 252 protrude from one and the other side edges of the main wall 251 toward the +Z side, respectively. Each of the side walls 252 is, for example, in the form of a rectangular plate shape parallel to the XZ plane. The side wall 252 extends in the X direction. The side wall 252 can restricts the movement of the light guide body 220 in the Y direction. The two side walls 252 may have a function of guiding the movement of the light guide body 220 in the front-rear direction.

A space surrounded by the main wall 251 and the two side walls 252 is an accommodation space which accommodates the light guide body 220.

A part (part on the +Z side) of the side wall 252 and a part (part on the +Z side) of the biasing structure 230 are arranged inside a holding protruding portion 121.

The biasing structure 230 is an elastic structure connected to the holding member 260. The biasing structure 230 is formed in a plate shape which can be elastically bend and deformed. The biasing structure 230 biases the light guide body 220 forward by an elastic repulsive force.

The biasing structure 230 connects rear ends of the two side walls 252. The biasing structure 230 is bridged between the rear end of one side wall 252 and the rear end of the other side wall 52. The biasing structure 230 is formed with a biasing portion 231 having a curved shape which is convex forward. The biasing portion 231 is curved, for example, in an arc shape in a plan view. The biasing portion 231 may be in the form of a plate curved in its thickness direction. At least a part of the biasing structure 230 is positioned rearwardly relative to the light guide body 220. The biasing structure 230 is formed integrally with the holding member 260, for example. The biasing structure 230 is constituted of the same material as the holding member 260, for example.

The holding unit 250 can be formed of rubber, a resin, or the like.

As illustrated in FIG. 12, a part of the light guide body 220 and a part of the holding unit 250 are accommodated into a space inside the holding protruding portion 121. A base 122 restricts the light guide body 220 and the holding unit 250 from moving backward. A side portion 123 restricts the light guide body 220 and the holding unit 250 from moving in the Y direction.

As illustrated in FIG. 17, when the light emitting portion 12 emits light, the light enters the main body 21 from a bottom surface 24a and a side surface 24b of the receiving recessed portion 24. A part of the light enters a tip protruding portion 22 and exits from a tip convex 26. Thus, the tip protruding portion 22 lights up.

The operation of the light guide body 220 and the biasing structure 230 will be described.

As illustrated in FIGS. 15 to 18, the light guide body 220 is switchable between a forward position (refer to FIGS. 15 and 17) and a rearward position (refer to FIGS. 16 and 18) by movement in the forward and backward directions. At the forward position (refer to FIGS. 15 and 17), the tip of the tip protruding portion 22 (the portion including the tip convex 26) protrudes from an outer surface 113b of a side plate 113. At the rearward position (refer to FIGS. 16 and 18), the tip protruding portion 22 assumes a state of not protruding from the outer surface 113b (i.e., a non-protruding state). Therefore, the tip protruding portion 22 can protrude from and retract into the outer surface 113b of the side plate 113.

As illustrated in FIGS. 15 and 17, at the forward position, for example, the biasing portion 231 of the holding unit 250 restricts the light guide body 220 from moving backward. Therefore, the state in which the part of the tip protruding portion 22 protrudes from the outer surface 113b is maintained.

As illustrated by an arrow in FIG. 17, there is a possibility that an external force may be applied to the tip protruding portion 22 serving as the portion protruded from the side plate 113 by coming into contact with an external object, etc. In the example illustrated in FIGS. 16 and 18, the application of the external force to the tip protruding portion 22 causes the light guide body 220 to retract, and the tip protruding portion 22 to enter a non-protruding state. As the light guide body 220 retracts, the biasing portion 231 is bent and deformed by being pushed by the light guide body 220. The biasing structure 230 presses the light guide body 220 forward with the elastic repulsive force. Therefore, when the external force weakens, the light guide body 220 returns to the forward position (refer to FIGS. 15 and 17).

[Effects Brought about by Electronic Apparatus According to Embodiment]

According to the electronic apparatus 200, the light guide body 220 allows the tip protruding portion 22 to be protruded and retracted from the side plate 113. Therefore, when the external force is applied to the tip protruding portion 22, the light guide body 220 retracts and the tip protruding portion 22 is brought into the non-protruding state. This can reduce the impact applied to the tip protruding portion 22, thereby making the tip protruding portion 22 less likely to be damaged. Since the tip protruding portion 22 can be protruded and retracted, it is also possible to make an external object less likely to be damaged when the external object comes into contact with the tip protruding portion 22.

Since the biasing structure 230 has the biasing portion 231 which obtains the repulsive force by bending deformation, it is possible to simplify the structure for biasing the light guide body 220.

Since the electronic apparatus 200 has the holding member 260, it is possible to suppress leakage of light from the light emitting portion 12.

Since the biasing portion 231 has the curved shape which is convex forward, the elastic repulsive force can be efficiently applied to the light guide body 220.

Since the main body 21 has the receiving recessed portion 24 which accommodates at least a part of the light emitting portion 12, it is possible to reduce the height dimensions (dimension in the Z direction) of the light guide body 220 and the light emitting unit 10. Therefore, it is possible to save space.

Since the first cover plate 111 is formed with the guide groove 125, the light guide body 220 can be operated stably.

### [Electronic Apparatus] (Third Embodiment)

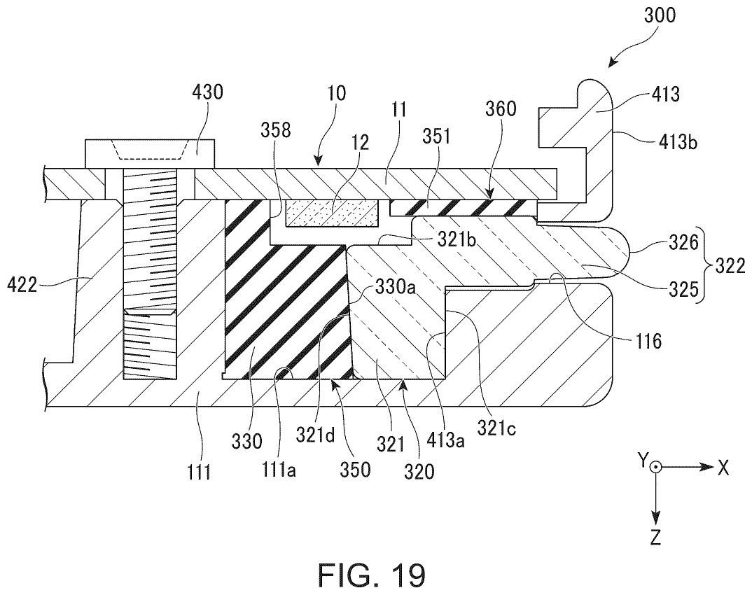

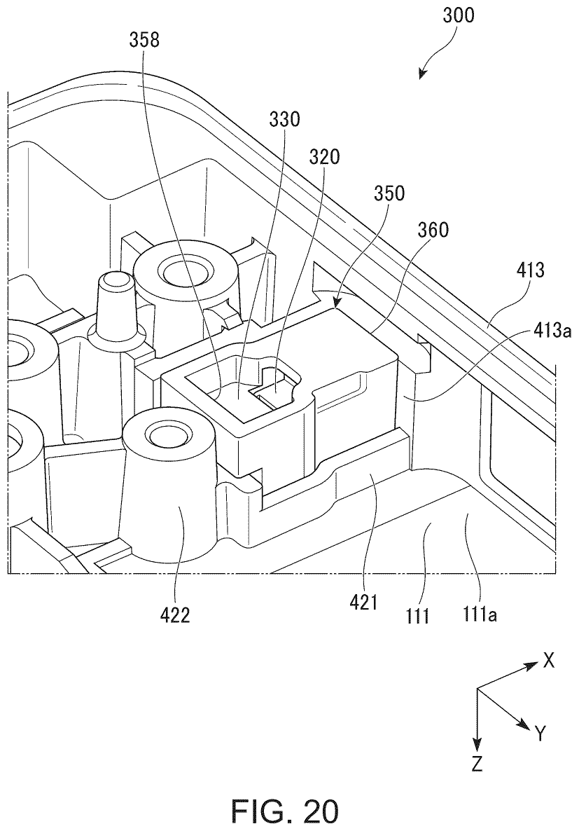

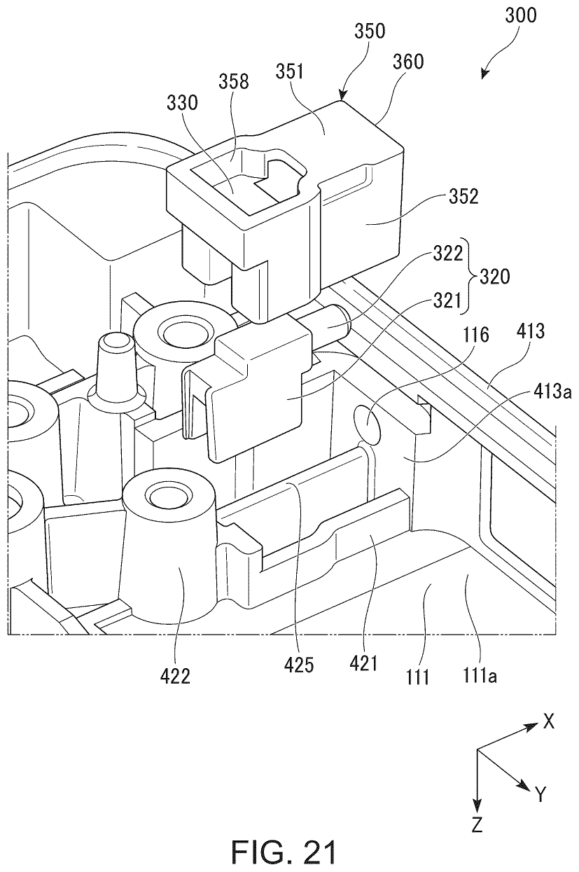

FIG. 19 is a cross-sectional view of a part of an electronic apparatus 300 according to a third embodiment. FIG. 20 is a perspective view of the part of the electronic apparatus 300. FIG. 21 is an exploded perspective view of the part of the electronic apparatus 300. Components common to the electronic apparatuses according to other embodiments are designated by the same reference numerals, and their description will be omitted.

As illustrated in FIGS. 19 to 21, the electronic apparatus 300 includes a first chassis 101 (refer to FIG. 1), a second chassis 102 (refer to FIG. 1), a light emitting unit 10, a light guide body 320, and a holding unit 350.

As illustrated in FIG. 20, a frame-shaped holding protruding portion 421 and one or more fixed protrusions 422 are formed on a surface 111a of a first cover plate 111.

As illustrated in FIG. 19, a substrate 11 of the light emitting unit 10 is fixed to the fixed protrusion 422 by a fixing tool 430.

As illustrated in FIG. 21, a guide protruding portion 425 (guide portion) is formed on a surface of a portion surrounded by the holding protruding portion 421 (surface on the −Z side of the first cover plate 111). The guide protruding portion 425 protruded to the −Z side. The guide protruding portion 425 extends in an X direction. The guide protruding portion 425 guides the light guide body 320 in a direction (front-rear direction) in which the light guide body 320 approaches and moves away from a side plate 413.

As illustrated in FIG. 19, the light guide body 320 has a main body 321 and a tip protruding portion 322.

The main body 321 is formed in a block shape. A front surface 321c of the main body 321 faces an inner surface 413a of the side plate 413. A rear end surface 321d is a surface opposite to the front surface 321c.

The tip protruding portion 322 protrudes forward (to the right in FIG. 19) from the front surface 321c of the main body 321. The tip protruding portion 322 is inserted into an insertion portion 116.

The tip protruding portion 322 has a main portion 325 and a tip convex 326. The main portion 325 is formed in a cylindrical shape having a central axis parallel to the X direction. The tip convex 326 is formed at the tip of the main portion 325. An outer surface of the tip convex 326 serves as a curved convex surface (e.g., a spherical surface) which is convex forward.

The main body 321 receives light emitted by a light emitting portion 12 through a second main surface 321b (the surface on the −Z side). The tip protruding portion 322 guides light from the main body 321 and emits it from the tip convex 326.

As illustrated in FIG. 21, the holding unit 350 includes a holding member 360 and a biasing structure 330.

The holding member 360 includes a main wall 351 and two side walls 352. The holding member 360 holds the light guide body 320 between the two side walls 352.

The main wall 351 is, for example, in the form of a plate parallel to an XY plane. The main wall 351 is formed with an opening portion 358. The opening portion 358 encompasses the light emitting portion 12 in a plan view. The main wall 351 is preferably in non-contact with the light guide body 320. When the main wall 351 is in non-contact with the light guide body 320, the light guide body 320 is made easier to operate in the front-rear direction.

The two side walls 352 protrude from one and the other side edges of the main wall 351 toward the +Z side, respectively.

As illustrated in FIG. 19, the biasing structure 330 is formed in a block shape. The biasing structure 330 is formed integrally with the holding member 360.

At least a part of the biasing structure 330 is provided on the rear side of the main body 321. A front surface 330a of the biasing structure 330 faces the rear end surface 321d of the main body 321.

The biasing structure 330 is elastically compressible and deformable in the front-rear direction. The biasing structure 330 biases the light guide body 320 forward by an elastic repulsive force. It is preferable that the biasing structure 330 has, for example, a durometer A hardness based on JISK6253-3(2012) of 70 or more and 90 or less.

The holding unit 350 can be formed of rubber, a resin, or the like.

The operation of the light guide body 320 and the biasing structure 330 will be described.

When the light guide body 320 is in the forward position, the tip of the tip protruding portion 322 (the portion including the tip convex 326) protrudes from the outer surface 413b of the side plate 413. When the light guide body 320 is in the rear position, the tip protruding portion 322 is brought into a state of being not protruded from the outer surface 413b (i.e., a non-protruding state).

There is a possibility that an external force may be applied to the tip protruding portion 322 serving as the portion protruded from the side plate 413 by coming into contact with an external object, etc. When the external force is applied to the tip protruding portion 322, the light guide body 320 retracts, and the tip protruding portion 322 enters a non-protruding state. As the light guide body 320 retracts, the biasing structure 330 is elastically compressed and deformed. The biasing structure 330 presses the light guide body 320 forward with the elastic repulsive force. Therefore, when the external force weakens, the light guide body 320 returns to the forward position.

[Effects Brought about by Electronic Apparatus According to Embodiment]

According to the electronic apparatus 300, the light guide body 320 allows the tip protruding portion 322 to be protruded and retracted from the side plate 413. Therefore, when the external force is applied to the tip protruding portion 322, the light guide body 320 retracts, and the tip protruding portion 322 is brought into the non-protruding state. This can reduce the impact applied to the tip protruding portion 322 and make the tip protruding portion 322 less likely to be damaged. Since the tip protruding portion 322 can be protruded and retracted, it is also possible to make the external object less likely to be damaged when the external object comes into contact with the tip protruding portion 322.

Since the biasing structure 330 obtains the repulsive force by compressive deformation, the biasing force is easily set. The biasing structure 330 is superior in durability compared to when utilizing bending deformation.

Since the electronic apparatus 300 has the holding member 360, it is possible to suppress leakage of light from the light emitting portion 12.

The specific configuration of the present invention is not limited to the above-described embodiments, and also includes designs and the like within the scope not departing from the gist of the present invention. The configurations described in the above-described embodiments can be combined arbitrarily.

In the electronic apparatus according to the embodiment, the configuration illustrated in FIG. 6 (light emitting unit 10, light guide body unit 40, and holding member 50) may be provided on only one of the two side plates 113, or on both of the two side plates 113.

In the example illustrated in FIG. 2, the insertion portion 116 through which the tip protruding portion 22 passes is formed in the side plate 113, but the insertion portion 116 is not limited to being formed in the side plate 113 and may be formed in the front plate 114 or the rear plate 115. The front plate 114 and the rear plate 115 are examples of side plates.

Although the electronic apparatuses 100, 200, and 300 according to the embodiments are laptop PCs, the electronic apparatuses are not limited to the laptop PCs and may be tablet terminals, smartphones, desktop PCs, and the like.

1. An electronic apparatus comprising:
a chassis having a cover plate and side plates each formed at a respective side edges of the cover plate;
a light emitting portion inside the chassis;
a light guide body has a tip protruding portion and guides light from the light emitting portion; and
a biasing structure which biases the light guide body,
wherein one of the side plates has an insertion portion which penetrates from an inner surface of the one of the side plates to an outer surface of the one of the side plates,
wherein the light guide body is movable in a direction of approaching and moving away from the one of the side plates, and
wherein the tip protruding portion is configured to protrude from the outer surface of the one of the side plates to protrude from and to retract into the insertion portion, and the biasing structure biases the light guide body in a protruding direction of the tip protruding portion by an elastic repulsive force.

2. The electronic apparatus according to claim 1, wherein the biasing structure is an elastic piece connected to the light guide body and produces the repulsive force by elastic bending deformation.

3. The electronic apparatus according to claim 2, further including a holding member which holds the light guide body,
wherein the holding member includes two side walls and a pressure receiving wall which connects the side walls together, and
wherein the biasing structure takes a reaction force against the pressure receiving wall to produce the repulsive force.

4. The electronic apparatus according to claim 1, further including a holding member which has two side walls and holds the light guide body between the two side walls,
wherein the biasing structure connects the two side walls together, and the biasing structure has a biasing portion which produces the repulsive force by elastic bending deformation.

5. The electronic apparatus according to claim 4, wherein the biasing portion has a convex shape in the protruding direction.

6. The electronic apparatus according to claim 1, wherein the light guide body has a receiving recessed portion which accommodates at least a part of the light emitting portion.

7. The electronic apparatus according to claim 1, wherein the biasing structure produces the repulsive force by elastic compressive deformation.

8. The electronic apparatus according to claim 1, wherein the cover plate has a guide portion which guides the light guide body in a direction in which the light guide body approaches and moves away from the one of the side plates.
